(19) United States
(12) Patent Application Publication
(10) Pub. No.: US 2008/0018557 A1
(43) Pub. Date: Jan. 24, 2008

(54) DISPLAY DEVICE, METHOD OF DRIVING DISPLAY DEVICE, AND ELECTRONIC APPARATUS

(75) Inventor: Hiroshi MAEDA, Hara-Mura (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/779,945

(22) Filed: Jul. 19, 2007

(30) Foreign Application Priority Data
Jul. 20, 2006 (JP) 2006-198655
Apr. 20, 2007 (JP) 2007-112064

(51) Int. Cl. G09G 3/20

(52) U.S. Cl. 345/55

(57) ABSTRACT

A display device has a plurality of pixels, a scanning line driving circuit, and a signal line driving circuit. The plurality of pixels are in correspondence with intersections of a plurality of scanning lines and a plurality of signal lines. The scanning line driving circuit supplies a selection signal to each of the plurality of scanning lines. The signal line driving circuit supplies a pixel signal to each of the plurality of signal lines. The plurality of pixels are arranged in a matrix in a display area of the display device. At least a specific area of the display area is an area in which at least one of the plurality of scanning lines obliquely intersects with at least one of the plurality of signal lines.

### BACKGROUND

1. Technical Field

The present invention relates to a display device in which pixels are arranged in a matrix, a method of driving the display device, and an electronic apparatus having the display device.

2. Related Art

In recent years, there has been a need for development of various types of information display devices owing to the miniaturization and diversification of electronic apparatuses. In regard to watches, for example, a new expensive watch, in which a digital display having a shape, such as a circular shape and an elliptical shape, is installed, has been developed and, therefore, displays having various shapes are required so as to conform to designs of the body, bracelet, or the like, of the watch.

However, an existing display, as described, for example, in Japanese Unexamined Patent Application Publication No. 2002-174823, has a plurality of scanning lines and a plurality of data lines, which are arranged lengthwise and widthwise on a rectangular substrate and drives pixels arranged in a grid. Thus, even when only a portion of an area having a circular shape or an elliptical shape within the entire display area of the display device is used so as to be viewed through the window of a watch case, a rectangular storage space is required within the watch case so as to conform to the rectangular substrate. Hence, there is a relatively large amount of area around the display area, which is not used for actual display. In addition, the outer peripheral area around the circular display area becomes a so-called window frame and, as a result, limits watch design.

As described above, when there is a wide window frame area around the display area of a product, product design becomes limited. This is disadvantageous, for example, in the design of watches. Furthermore, because the aperture ratio of the display unit in a product is lowered, there arise problems that contents that can be displayed on the screen are limited and the display is not easily understood.

### SUMMARY

An advantage of some aspects of the invention is that a display device that allows more freedom of product design by making the shape of a display unit substrate be approximated to a circular shape or an elliptical shape that conforms to a circular or elliptical display screen is provided.

A first aspect of the invention provides a display device that includes a plurality of pixels, a scanning line driving circuit, and a signal line driving circuit. The plurality of pixels are arranged in correspondence with intersections of a plurality of scanning lines and a plurality of signal lines. The scanning line driving circuit supplies a selection signal to each of the plurality of scanning lines. The signal line driving circuit supplies a pixel signal to each of the plurality of signal lines. The plurality of pixels are arranged in a matrix in a display area of the display device. At least a specific area of the display area is an area in which at least one of the plurality of scanning lines obliquely intersect with at least one of the plurality of signal lines.

According to the first aspect of the invention, because the plurality of scanning lines and the plurality of signal lines obliquely intersect each other in the specific area of the display area, distances between wirings are made narrow owing to the obliquely arranged wirings, thus reducing an area of arrangement for driving circuits that are arranged around the display area (or an area required for external connection with the plurality of scanning lines or the plurality of signal lines). In this manner, because the scanning line driving circuit, the signal line driving circuit, terminals for connection with an external driving circuit, the crown of a watch, or the like, may be arranged appropriately along the outer periphery of the display area (formed in an octagonal shape, circular shape, elliptical shape, or the like), the aperture ratio relative to a product shape may be improved (the width of the window frame may be made small).

At least one of the plurality of scanning lines and the plurality of signal lines may be bent at a boundary between the specific area and the other area of the display area. According to this configuration, because at least a portion of the plurality of scanning lines and plurality of signal lines are bent, both areas, that is, an oblique intersection area and an non-oblique intersection area, may be formed by one group of wirings, thus making it possible to increase the possibility of wiring arrangement. Note that the scanning lines and the signal lines both may be formed linearly (not bent). In this case, the entire display area is an oblique intersection area.

The display area may have an octagonal shape. When the display area has an octagonal shape, the oblique intersection area may be applied to an area in which the shape of the display area has an oblique side, thus making it possible to effectively use the advantage of reduced space utilizing the oblique intersection area. In particular, when the product has, for example, a circular shape or an elliptical shape, the aperture ratio relative to the product shape may be increased.

It is preferable that the scanning line driving circuit and the signal line driving circuit each are disposed along at least a part of an outer periphery of the display area. According to this configuration, by forming the peripheral circuits along the outer periphery of the display area, the peripheral circuits may require a further reduced space when the peripheral circuits are mounted together.

It is preferable that the plurality of pixels each have a rectangular shape, wherein, in the specific area, one of the plurality of scanning lines and the plurality of signal lines are arranged in parallel with one of a lengthwise side and widthwise side of each of the plurality of pixels, and the other of the plurality of scanning lines and the plurality of signal lines are arranged in parallel with a diagonal line of each of the plurality of pixels. According to this configuration, a group of pixels that are arranged in a matrix may be easily made in correspondence with a group of wirings of the scanning lines and signal lines.

Note that, in the description, the “shape of a pixel” refers to the shape of a minimum unit that forms an image and, specifically, the shape of a pixel electrode corresponds to the shape of a pixel.

It is preferable that, when the display area has an octagonal shape which is formed by chamfering the four corners of a rectangle, one of the plurality of scanning lines and the plurality of signal lines are disposed so as to be orthogonal to one side positioned at the upper side of the octagonal shape, and the other of the plurality of scanning lines and the plurality of signal lines, in at least a portion of the display area, are disposed in parallel with a side next to the above upper side of the octagonal shape, wherein intervals of the scanning lines and intervals of the signal lines are adjusted so that intersections of the scanning lines and the signal lines are aligned lengthwise and widthwise in a matrix. According to this configuration, pixels may be efficiently arranged in a matrix over the entire display area.

It is preferable that the display area has a substantially regular octagonal shape, wherein one of the plurality of scanning lines and the plurality of signal lines are arranged so as to be orthogonal to one side of the shape of the display area, and the plurality of scanning lines and the plurality of signal lines are arranged to obliquely intersect each other at approximately an angle of 45 degrees in the specific area. According to this configuration, when the shape of a pixel is square, the pixels may be efficiently aligned in a matrix over the entire display area.

The specific area may include a plurality of areas in which the plurality of scanning lines and the plurality of signal lines obliquely intersect each other at different angles.

In addition, it is preferable that, at boundaries between any adjacent plurality of areas in which the plurality of scanning lines and the plurality of signal lines obliquely intersect each other at different angles, at least one of the plurality of scanning lines and the plurality of signal lines are bent. According to this configuration, even when the specific area includes an area in which the size of pixels is different from the other specific area, the plurality of scanning lines and the plurality of signal lines may be efficiently arranged. For this reason, by arranging a plurality of areas in which pixels having a different size are arranged, it is possible to deal with the display area having an arbitrary shape.

Moreover, it is preferable that the display device further includes a storage portion that stores image data to be displayed in the display area and an image array conversion portion that controls the storage portion, wherein the image array conversion portion uses first addresses when writing the image data into the storage portion in a first order that corresponds to the sequence of an array of the plurality of pixels, the image array conversion portion uses second addresses when writing the image data into the storage portion in a second order that corresponds to the sequence based on the selection signal, and the image array conversion portion uses the second addresses when reading out the image data, which are stored in the storage portion, into the display area. According to this configuration, when the image data are not sorted in advance in correspondence with the sequence of the pixels corresponding to the selection signal, the first addresses are used to write the image data into the storage portion, and, when the image data are sorted in advance in correspondence with the sequence of the pixels corresponding to the selection signal, the second addresses are used to write the image data into the storage portion, thus making it possible to omit a process of sorting the image data before writing into the storage portion. By adding a tag or flag with which it is identified whether the first addresses are used or the second addresses are used for the image data, the image array conversion portion may determine which addresses are used by identifying the tag or flag.

Furthermore, it is preferable that the storage portion has a capacity that is capable of storing a plurality of pieces of image data, an operation (reading operation) by which the image data to be displayed in the display area are read out from a first storage area of the storage portion is executed in parallel with an operation (writing operation) by which the image data are written, using the first addresses, into a second storage area of the storage portion, which is different from the first storage area where the read image data are stored. In this manner, while the image data are being read from the storage portion, the image data that will be displayed next may be stored in the storage portion, thus making it possible to quickly switch a display image.

A second aspect of the invention provides a display device that includes a display area, a plurality of signal lines, a plurality of scanning lines, a signal line driving circuit, a scanning line driving circuit, and a plurality of pixel driving circuits. The display area is formed of a plurality of pixels arranged in a first area and second area of the display area. The plurality of signal lines extend in one direction in the first area and in the second area. The plurality of scanning lines orthogonally intersect with a portion of the plurality of signal lines in the first area and obliquely intersect with another portion of the plurality of signal lines in the second area. The signal line driving circuit is arranged along a part of an outer periphery of the first area and second area (display area) and supplies a pixel signal to each of the plurality of signal lines. The scanning line driving circuit is arranged along another part of the outer periphery of the second area and supplies a selection signal to each of the plurality of scanning lines. The plurality of pixel driving circuits are respectively provided at intersections of the plurality of scanning lines and the plurality of signal lines and drive the pixels on the basis of the pixel signal and the selection signal.

According to the above configuration, because the first area (orthogonal intersection area) and the second area (oblique intersection area) are provided, the possibility of wiring arrangement is improved when a display unit having pixels arranged in a matrix is formed to have a display area with a partially inclined shape. For example, signal input terminals for sending various signals to the scanning lines and the signal lines, the scanning line driving circuit, the signal line driving circuit, the crown of a watch, or the like, are easily arranged at lengthwise, widthwise and oblique positions around the display area. As a result, the aperture ratio relative to a product shape may be improved (the width of the window frame may be made small). Thus, it is suitable for a (polygonal, circular, or elliptical) display unit of a watch that attaches weight to its product design.

A third aspect of the invention provides a display device that includes an octagonal display area, a plurality of signal lines, a plurality of scanning lines, a signal line driving circuit, a scanning line driving circuit, and a plurality of pixel driving circuits. The display area is formed of a plurality of pixels arranged in a matrix. The plurality of signal lines extend in one direction of the display area. The plurality of scanning lines orthogonally intersect with a portion of the plurality of signal lines in a first area of the display area and obliquely intersect with another portion of the plurality of signal lines in a second area of the display area. The signal line driving circuit is arranged along a part of an outer periphery of the first area and second area of the display area and supplies a pixel signal to each of the plurality of signal lines. The scanning line driving circuit is arranged along another part of the outer periphery of the second area of the display area and supplies a selection signal to each of the plurality of scanning lines. The plurality of pixel driving circuits are respectively provided at intersections of the plurality of scanning lines and the plurality of signal lines and drive the pixels on the basis of the pixel signal and the selection signal.

According to the above configuration, because the possibility of wiring arrangement is increased owing to the provision of the first area (orthogonal intersection area) and the second area (oblique intersection area), and, for example, signal input terminals for sending various signals to the scanning lines and the signal lines, the scanning line driving circuit, the signal line driving circuit, and the crown of a watch may be arranged in accordance with the shape of an octagonal display area and a product shape, it is suitable for improvement of aperture ratio relative to a product shape (the width of the window frame may be made small). In addition, when the display area has an octagonal shape, the scanning line may be arranged to be inclined at an angle of 45 degrees with respect to a lengthwise side of the display area or at an angle of 90 degrees with respect to an inclined side of the display area. Thus, the pattern design of a substrate becomes relatively easy.

A fourth aspect of the invention provides a display device that includes a display area, a plurality of signal lines, a plurality of scanning lines, a signal line driving circuit, a scanning line driving circuit, and a plurality of pixel driving circuits. The display area is formed of a plurality of pixels arranged in a matrix. The plurality of signal lines extend in one direction in the display area. The plurality of scanning lines obliquely intersect with the plurality of signal lines in the display area. The signal line driving circuit is arranged along a part of an outer periphery of the display area and supplies a pixel signal to each of the plurality of signal lines. The scanning line driving circuit is arranged along another part of the outer periphery of the display area and supplies a selection signal to each of the plurality of scanning lines. The plurality of pixel driving circuits are respectively provided at intersections of the plurality of scanning lines and the plurality of signal lines and drive the pixels on the basis of the pixel signal and the selection signal.

According to the above configuration, because the possibility of wiring arrangement is increased owing to the signal lines and the scanning lines that obliquely intersect each other, and the arrangement of signal input terminals for sending various signals to the scanning lines and the signal lines and the arrangement of the scanning line driving circuit and signal line driving circuit may be, for example, changed in accordance with the shape of the display area and a product shape, it contributes to improvement of aperture ratio relative to a product shape. In addition, by making the entire display area as the oblique intersection area, the display area may be formed of pixel cells of a single type. This simplifies a manufacturing process as compared with the display area that is formed of both the orthogonal intersection area and the oblique intersection area.

It is preferable that the display device further includes a pixel array conversion portion. The pixel array conversion portion writes supplied image data, which will be displayed in the display area, into the storage portion in a first order or in a second order and supplies the image data to the signal line driving circuit by reading the image data from the storage portion in the second order or in the first order in correspondence with the first order or the second order, in which the image data have been written into the storage portion. The writing or reading in the first order is executed at first addresses that correspond to an array in which the pixels are arranged in the display area. The writing or reading in the second order is executed at second addresses that correspond to an array in which the pixels are sequentially driven by the plurality of scanning lines and the plurality of signal lines, which include wirings that obliquely intersect each other. According to this configuration, original image data, which are based on a display unit (with a rectangular display area) having an array in which the pixels are driven by the plurality of scanning lines and the plurality of signal lines that orthogonally intersect each other, may be converted (pixel position conversion) and used for a display unit partially having inclined wirings of the plurality of scanning lines and plurality of signal lines so as to conform to the transformed display area, thus making it possible to use an existing image data (two-dimensional array). In addition, the provision of the pixel array conversion portion can remove an image data conversion process executed in advance by an external device.

It is preferable that the pixel array conversion portion is provided with an address conversion table with which an address that is based on an orthogonal coordinate system (first address) is converted to an address that is based on a coordinate system defined by the scanning lines and the signal lines. Thus, conversion of coordinates becomes easy, making it possible to realize high-speed processing.

One or both of the scanning line driving circuit and the signal line driving circuit may be formed in plural numbers. Because the wirings of the scanning lines and/or the wirings of the signal lines are respectively shared by the plurality of scanning line driving circuits and/or the plurality of signal line driving circuits, the possibility of arrangement of the scanning lines, signal lines, scanning line driving circuit(s) and signal line driving circuit(s) is increased.

A fifth aspect of the invention provides an electronic apparatus provided with the above described display device. According to this configuration, the size of the electronic apparatus is reduced and the possibility of shape design of the electronic apparatus is improved, while making it possible to improve the aperture ratio relative to a product shape (the width of the window frame may be made small).

A sixth aspect of the invention provides a method of converting an image data for use in a display device that includes a display area that is formed of pixels arranged in a matrix in correspondence with intersections of a plurality of scanning lines and a plurality of signal lines, wherein the display area at least partially includes an oblique intersection area in which the scanning lines and the signal lines obliquely intersect each other. The method includes writing supplied image data, which will be displayed in the display area, into a storage portion in a first order or in a second order, and converting an array of pixels in the image data by reading the image data from the storage portion in the second order or in the first order that corresponds to the first order or the second order in which the image data have been written into the storage portion, wherein the writing or reading in the first order is executed using first addresses that correspond to an array in which the pixels are arranged in the display area, and the writing or reading in the second order is executed using second addresses that correspond to an array in which the pixels are sequentially driven by the plurality of scanning lines and the plurality of signal lines, which include wirings that obliquely intersect each other.

According to the sixth aspect, because there is provided a device that converts original image data to image data for output (output image data), it is possible, when image data are output, to convert the original image data, which are stored in the storage portion (image memory), to the output image data appropriate for the arrangement pattern of scanning lines and signal lines.

### BRIEF DESCRIPTION OF THE DRAWINGS

The invention will be described with reference to the accompanying drawings, wherein like numbers reference like elements.

FIG. 1 is a schematic view of an active matrix electrophoretic display device (EPD) according to a first embodiment of the invention.

FIG. 2A and FIG. 2B are explanatory views each illustrating a specific configuration of unit pixels.

FIG. 3A is an explanatory view illustrating a positional relationship among signal lines, scanning lines, and pixel electrodes.

FIG. 3B is an explanatory view illustrating a positional relationship in an oblique intersection area between a pixel driving circuit and a pixel electrode.

FIG. 4A and FIG. 4B are schematic cross-sectional views each illustrating an example of configuration of an electrophoretic display element.

FIG. 5A and FIG. 5B are explanatory views each illustrating the arrangement of pixel(s) of a display device that is provided with an elongated octagonal display area according to a second embodiment of the invention.

FIG. 6 is an explanatory view illustrating a wiring pattern of a display area of a display device according to a third embodiment of the invention.

FIG. 7 is an explanatory view illustrating a display device according to a fourth embodiment of the invention.

FIG. 8A is an image that is displayed in the display screen of the display device.

FIG. 8B is an image that is converted from the image of FIG. 8A in accordance with a wiring pattern.

FIG. 9 is an explanatory view schematically illustrating a pixel array conversion portion of the display device according to the embodiments of the invention.

FIG. 10 is a block diagram of a data driver.

FIG. 11 is a view showing a configuration example of a display device in which scanning lines and signal lines obliquely intersect each other at a plurality of different angles.

FIG. 12 is a partially enlarged view showing a configuration example of the display device in which the scanning lines and the signal lines obliquely intersect each other at the plurality of different angles.

FIG. 13 is a schematic view of the display area of a display body for the purpose of illustrating a seventh embodiment of the invention.

FIG. 14 is a view showing an example of arrangement of image data for one screen.

FIG. 15 is a view showing the correspondence between first addresses and second addresses.

FIG. 16 is a view showing the correspondence between first addresses and second addresses.

FIG. 17 is a block diagram showing a portion of a display device according to an eighth embodiment of the invention.

FIG. 18 is a block diagram showing a memory portion and one example of a detailed configuration of an address switching portion.

FIG. 19A and FIG. 19B are schematic perspective views each showing an example of an electronic apparatus.

### DESCRIPTION OF EXEMPLARY EMBODIMENTS

Example embodiments of the invention will be described with reference to the accompanying drawings.

### First Embodiment

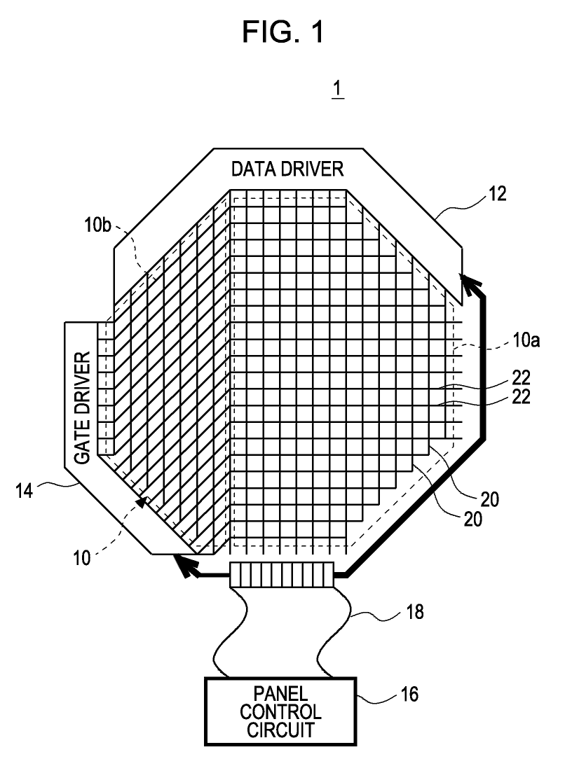

FIG. 1 is a schematic view of an active matrix electrophoretic display device (EPD) according to a first embodiment.

As shown in FIG. 1, the display device 1 includes a display area 10 that is formed of a plurality of pixels arranged in a matrix, a data driver (signal line driving circuit) 12, a gate driver (scanning line driving circuit) 14, and a panel control circuit 16.

The panel control circuit 16 controls the data driver 12 and the gate driver 14. The panel control circuit 16 includes a pattern generator, a pixel array conversion portion, a timing generator, or the like, which are not shown in the drawing. The panel control circuit 16 generates image data (image signals) that form an image to be displayed in the display area 10 and other various signals (clock signals, etc.) and outputs the signals to the data driver 12 and the gate driver 14. Specifically, for example, the pattern generator generates image data by receiving calendar information (year, month, day, weekday, hour, minute, second) from a clock CPU (not shown) with which the function of a clock is integrated. The image data are, for example, generated as a data array of pixels obtained by sequentially scanning a two-dimensional image. The pixel array conversion portion, which will be described later, rearranges the pixel positions in the array of pixel data according to an order in which the pixels are driven by the scanning lines and the signal lines, which are wired in accordance with the display area of a transformed display unit. The pixel array conversion portion sends the image data, whose pixel positions are adjusted, to the data driver 12. In addition, the timing generator generates various timing signals for controlling the above internal circuits of the panel control circuit 16, the gate driver 14 and the data driver 12. Note that the panel control circuit 16 is electrically connected to the data driver 12 and the gate driver 14 through wirings 18 of, for example, a substrate terminal, a flexible printed circuit (FPC), or the like.

The display area 10 has an octagonal shape having interior angles of approximately 135 degrees. A plurality of signal lines (data lines) 20 that extend in one direction (vertical direction in the drawing) and a plurality of scanning lines (gate lines) 22 that are partially bent (in the form of broken line) are arranged in the display area 10. The display area 10 includes an orthogonal intersection area (first area) 10a in which the signal lines 20 and the scanning lines 22 orthogonally intersect each other and an oblique intersection area (second area) 10b in which the signal lines 20 and the scanning lines 22 obliquely intersect each other. In the orthogonal intersection area 10a, the signal lines 20 are arranged perpendicularly (orthogonally) to one side (reference side) of the octagonal shape, arranged in columns perpendicular to the uppermost side shown in the drawing, and the scanning lines 22 are arranged perpendicularly to a side that extends vertically at a position from an inclined side on the right-hand side of the above reference side, that is, in a direction perpendicular to the signal lines 20. In the oblique intersection area 10b, the signal lines 20 are arranged in the same direction as those in the orthogonal intersection area 10a, and the scanning lines 22 are arranged in a direction parallel to an inclined side on the left-hand side next to the reference side of the octagonal shape, that is, in a direction in which the scanning lines 22 intersect with the signal lines 20 at an angle of 45 degrees. The intervals of the signal lines 20 and the intervals of the scanning lines 22 are determined so that intersections of the signal lines 20 and the scanning lines 22 are aligned in lines even in the lengthwise direction or in the widthwise direction. Because the signal lines 20 and the scanning lines 22 are thus arranged, as will be described later, pixels may also be arranged in a matrix in the oblique intersection area 10b as in the case of the orthogonal intersection area 10a.

A unit pixel that includes a pixel driving circuit and a pixel electrode is formed at each of the intersections of the signal lines 20 and the scanning lines 22. Because the intersections are arranged as described above, the pixel electrodes each having the same shape may also be arranged in the oblique intersection area 10b at the same intervals as in the case of the orthogonal intersection area 10a. In this embodiment, the shape of each pixel electrode is substantially that of a regular square, and, in the oblique intersection area 10b, the pixel electrodes are arranged so that the diagonal line of each pixel electrode is aligned with one of the scanning lines 22. An image (two-dimensional information) is displayed by means of an electrophoretic display element included in each unit pixel.

Note that, in the description, the display area means an area in which pixels may be arranged theoretically by arranging the signal lines 20 and the scanning lines 22 lengthwise, widthwise or obliquely (an area in which wirings are formed). In addition, according to an aspect of the invention, pixels need not be formed at all of the intersections of the signal lines 20 and the scanning lines 22 in the display area 10. For example, when the octagonal display area 10 is covered with a frame (outer case) having a window narrower than the display area 10, pixels need not be formed at portions that are covered with the frame and that cannot be viewed from the outside. This can reduce the number of pixels that do not contribute to display and can simplify the configuration of a display device.

The gate driver 14 is arranged along two adjacent sides of the octagonal display area 10. The output terminals of the gate driver 14 are electrically connected to the scanning lines 22 of the display area 10, and each sequentially supplies a predetermined scanning line selection signal (drive signal) to each of the scanning lines 22. The selection signal is a signal that an active period (H level period) sequentially shifts the scanning lines 22. When the selection signal is output to each of the scanning lines 22, the pixel driving circuits, which will be described later, that are electrically connected to each of the scanning lines 22 are sequentially turned on.

The data driver 12 is provided so as to extend over the upper three sides of the octagonal shape along the outer periphery of the display area 10 at a position adjacent to the gate driver 14. The output terminals of the data driver 12 are electrically connected to the signal lines 20 of the display area 10 and supply a data signal (pixel signal) to each of the pixel driving circuits selected by the gate driver 14 (in an ON state). Note that the configuration of the data driver 12 will be described later.

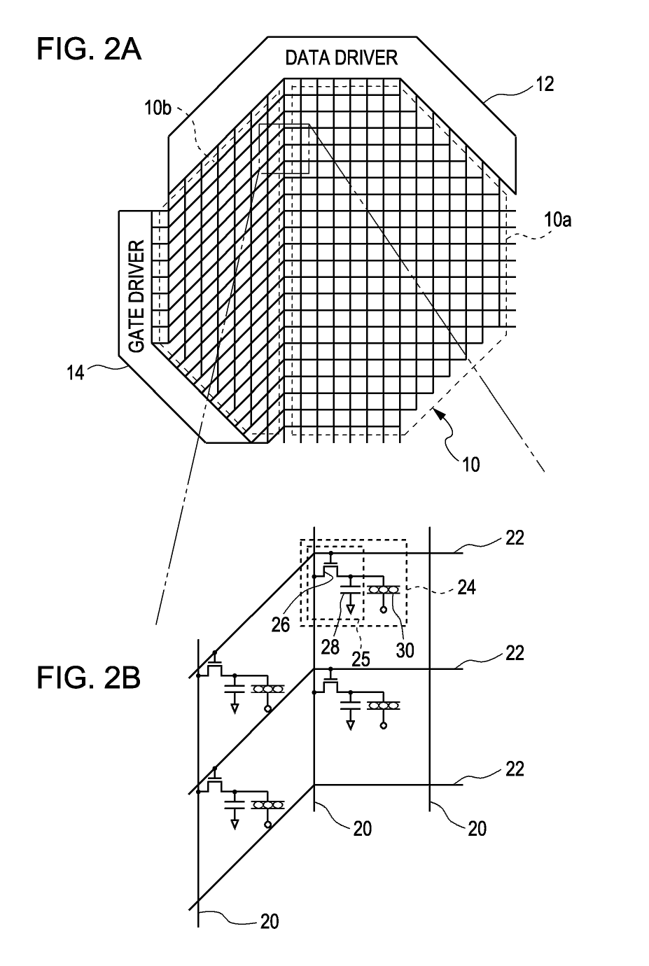

FIG. 2A and FIG. 2B are explanatory views each illustrating a specific configuration of unit pixels. In FIG. 2A and FIG. 2B, the components corresponding to those shown in FIG. 1 are given the same reference numerals, and description thereof is omitted.

FIG. 2A shows the display area of the display unit. FIG. 2B shows the pixel driving circuits of the pixels that form the display area. As shown in FIG. 2B, the unit pixel 24 includes a pixel driving circuit 25, which has a switching thin-film transistor (TFT) 26 and a hold capacitor 28, and an electrophoretic display element 30. The thin-film transistor 26 is, for example, an N-channel transistor in which a gate is electrically connected to a corresponding one of the scanning lines 22, a source is electrically connected to a corresponding one of the signal lines 20 and a drain is electrically connected to the pixel electrode of the electrophoretic display element 30. The electrophoretic display element 30 is formed by interposing an electrophoretic layer between the pixel electrode provided for each pixel and a common electrode used in common with other pixels. The hold capacitor 28 is electrically connected in parallel with the electrophoretic display element 30 and holds a voltage applied to the pixel electrode by the thin-film transistor 26.

In the above configuration, as the selection signal is supplied to a selected one of the scanning lines 22 and the pixel data signals are supplied to the signal lines 20 synchronously with the supply of the selection signal, the pixel driving circuits 25 set luminance corresponding to the levels of the pixel data signals for a group of pixels (electrophoretic display elements) 30 that are electrically connected to the above scanning line 22. When writing of pixel data is executed for a group of pixels of each of the scanning lines 22 in the same manner, an image is formed in the display area. The luminance level of each pixel is held by the hold capacitor 28 until data are updated on the basis of the next image frame. Note that the supply of image data to the display unit, which supports the existence of an inclined area, will be described later in another embodiment.

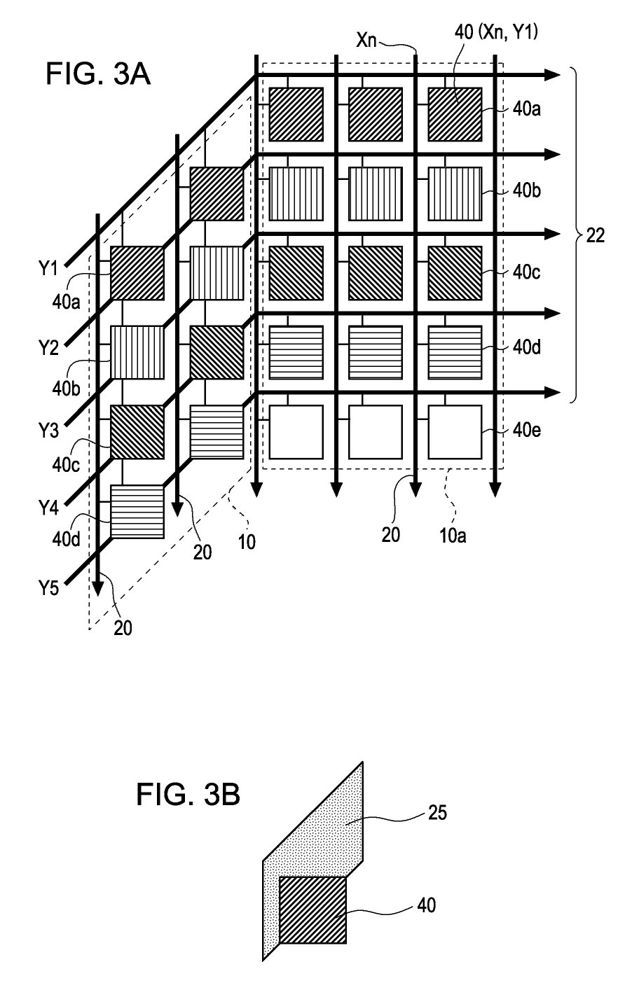

FIG. 3A is an explanatory view illustrating a positional relationship among the signal lines 20, the scanning lines 22 and the pixel electrodes 40 (hereinafter, also referred to as pixels). FIG. 3B is an explanatory view illustrating a positional relationship in the oblique intersection area 10b between an area of the pixel driving circuit 25 and an area of the pixel electrode 40.

As shown in FIG. 3A, the pixel electrodes 40 are arranged in a matrix at positions corresponding to the intersections of the signal lines 20 and the scanning lines 22. The pixel electrodes 40 will be sequentially driven along each of the scanning lines 22. Specifically, a group of pixels that are arranged along a selected scanning line 22 will be sequentially driven so that, in the plurality of scanning lines 22, a group of pixels 40a that are arranged along a scanning line Y1 are driven when the scanning line Y1 shown in the drawing is selected (the selection signal Y1 is supplied), a group of pixels 40b are driven when a scanning line Y2 is selected, and a group of pixels 40c are driven when a scanning line Y3 is selected, and the like, accordingly. Because pixel data (pixel signals) are supplied from the signal lines 20 synchronously with the driving of each of the scanning lines 22, respective luminance information is held at a group of pixels corresponding to the selected scanning line 22. For example, a pixel 40 (Xn, Y1), which is a pixel of the pixel group 40a, is driven through the pixel driving circuit that is electrically connected to the signal line 20 at Xn and the scanning line 22 at Y1 and the luminance information is then held.

In addition, as shown in FIG. 3B, in the oblique intersection area 10b in which the signal lines 20 and the scanning lines 22 obliquely intersect each other, the pixel driving circuit 25 is formed in a parallelogram area defined by two signal lines 20 and two scanning lines 22, and the pixel electrode 40 that drives the pixel driving circuit 25 is provided as an upper layer so as to partially overlap the pixel driving circuit 25.

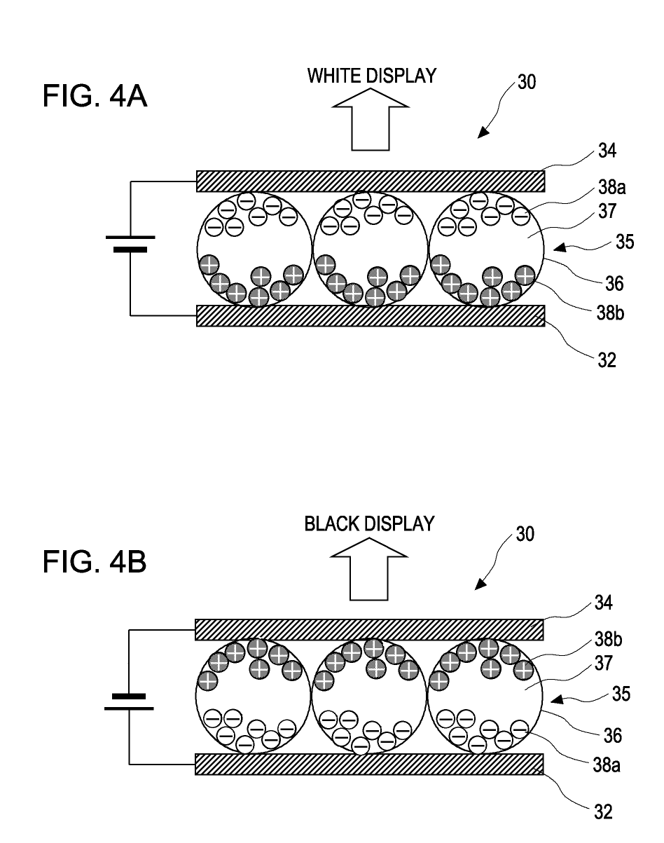

FIG. 4A and FIG. 4B are schematic cross-sectional views each illustrating a configuration example of an electrophoretic display element. As shown in FIG. 4A and FIG. 4B, the electrophoretic display element 30 in this embodiment includes a pixel electrode 32 (which corresponds to the component denoted by the reference numeral 40 in FIG. 3A and FIG. 3B) formed on a substrate (not shown) made of glass, resin, or the like, a common electrode 34 formed on an optically transparent substrate (not shown) made of glass, resin, or the like, and an electrophoretic layer 35 interposed between the pixel electrode 32 and the common electrode 34. The pixel electrode 32 need not be a transparent electrode. The pixel electrode 32 is, for example, formed of an indium tin oxide (ITO) film, or the like. The common electrode 34 employs a transparent electrode that is optically transparent, and is formed, for example, of an ITO film, or the like. The electrophoretic layer 35 is formed of a multiple number of microcapsules 36 that are fixed using binder. Each of the microcapsules 36 contains dispersion medium (dispersion liquid) 37 and electrophoretic particles 38a, 38b. Here, the electrophoretic particles 38a are white particles that are electrically charged negatively, and the electrophoretic particles 38b are black particles that are electrically charged positively.

The principle of image display of the electrophoretic display device 1 according to the present embodiment will now be described.

In the electrophoretic display device 1 according to the present embodiment, by controlling the voltage applied between the pixel electrode 32 and the common electrode 34, the spatial arrangement of these electrophoretic particles 38a, 38b is changed and the dispersion state of the electrophoretic particles in the pixels is changed, thus realizing image display. Specifically, for example, as shown in FIG. 4A, as the negative voltage based on the common electrode 34 is applied to the pixel electrode 32, the white electrophoretic particles 38a that are charged negatively move toward the common electrode 34 disposed on the side of a display surface on the basis of Coulomb force, and the black electrophoretic particles 38b that are charged positively move toward the pixel electrode 32, so that white color is displayed on the display surface. On the other hand, as shown in FIG. 4B, as the positive voltage based on the common electrode 34 is applied to the pixel electrode 32, the black electrophoretic particles 38b that are charged positively gather near the common electrode 34 disposed on the side of the display surface, and the white pixel electrophoretic particles 38a that are charged negatively gather near the pixel electrode 32, so that black color is displayed on the display surface.

The electrophoretic particles 38a, 38b are set so that the specific gravities of the electrophoretic particles 38a, 38b are approximately equal to the specific gravity of the dispersion medium 37. Thus, even after the application of an electric field to the electrophoretic display element 30 (electrophoretic layer 35) is interrupted, it is possible to maintain the electrophoretic particles 38a, 38b at a predetermined position within the electrophoretic layer 35 for a long time.

The movement speed of the electrophoretic particles 38a, 38b is determined depending on the strength of the electric field (applied voltage). The movement distance of the electrophoretic particles 38a, 38b is determined depending on the applied voltage and the amount of time that the voltage is applied. Thus, by adjusting the applied voltage and the amount of time that the voltage is applied, the electrophoretic particles 38a, 38b may be moved between the electrodes.

As described above, according to the present embodiment, because the scanning lines 22 are formed in broken lines to obliquely intersect with the signal lines 20 in the specific area of the display area 10, the signal input terminals of the signal lines 20 and scanning lines 22 may be arranged at desired positions of sides around the octagonal display area. Thus, the arrangement of the gate driver 14 and the data driver 12 for sending various signals to the scanning lines 22 and the signal lines 20 and the arrangement of the connection terminals with the panel control circuit 16 may be aligned along the outer periphery of the display area 10, thus making it possible to make the width of the window frame small. In addition, in the present embodiment, because there may be smaller area required for image conversion processing, which will be described in a fifth embodiment, by leaving the orthogonal intersection area 10a, the display speed may be increased as compared with the configuration when the entire surface is an oblique intersection area. In addition, because the display area has an octagonal shape, it is possible to effectively use the advantage of reduced space using the oblique intersection area.

Note that, in the above described embodiment, the arrangement in which pixels are linearly aligned lengthwise and widthwise is described but it is not limited to this configuration. The matrix array of pixels may be, for example, an arrangement in which pixels are shifted by ½ pitch every row like as the delta arrangement of a color display device. In addition, the intervals of the signal lines 20 and the intervals of the scanning lines 22 may be appropriately changed in accordance with the arrangement of pixels so that the intersections of the signal lines 20 and the scanning lines 22 are arranged at positions corresponding to the pixels. In this manner, the arrangement of pixels may be suitable for image data to be displayed. Note that the same applies to the following embodiments.

Furthermore, in the above example, an example in which the gate driver 14 and the data driver 12 are arranged around the display area 10 is described but it is not limited to this configuration. The gate driver 14 and the data driver 12 may be arranged externally.

### Second Embodiment

The shape of pixels in the first embodiment is square, whereas the shape of pixels used in the second embodiment is rectangular.

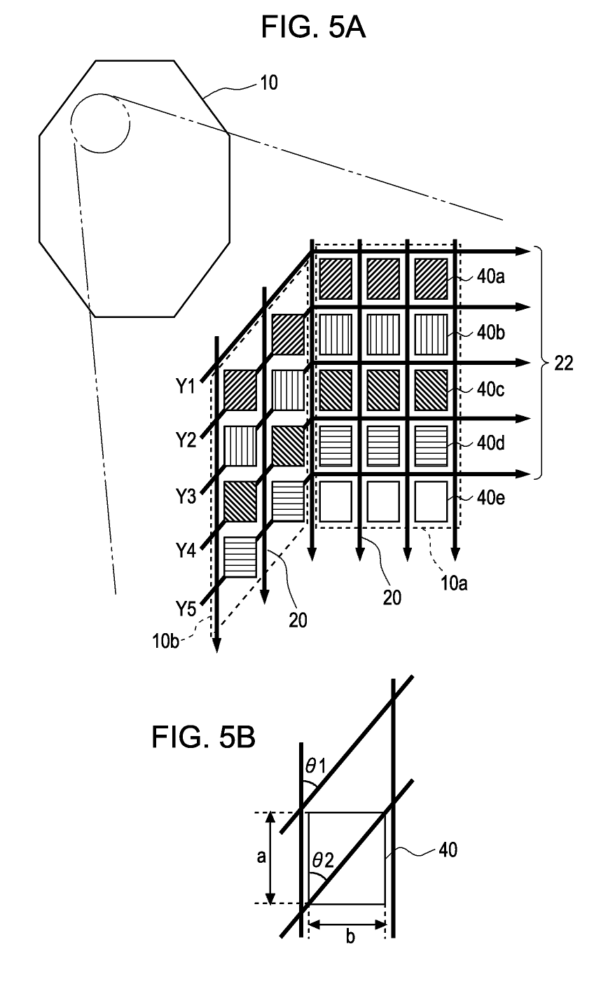

FIG. 5A and FIG. 5B are explanatory views each illustrating the arrangement of pixel(s) of a display device that is provided with an elongated octagonal display area according to the second embodiment of the invention. FIG. 5A is a partially enlarged view showing the shape of the display area, and the oblique intersection area and orthogonal intersection area of the display area. FIG. 5B shows a positional relationship between the scanning line and the pixel. In FIG. 5A and FIG. 5B, the components corresponding to those shown in FIG. 2 are given the same reference numerals, and description thereof is omitted.

When the display area 10 has an elongated octagonal (elliptical) shape as shown in FIG. 5A, the scanning lines 22 are arranged in parallel with the oblique side of the display area 10 in the oblique intersection area 10b. In addition, the ratio of the long side to the short side of the rectangular shape (the ratio of length to width) of the pixel (pixel electrode) 40 is determined in accordance with the inclination angle of the oblique side. That is, as shown in FIG. 5B, the ratio is tan(θ2)=b/a, where the reference signs a, b denote the lengths of lengthwise side and widthwise side of the pixel, respectively, and θ2 denotes an angle made between the lengthwise side of the pixel 40 and the diagonal line of the pixel 40. In addition, θ2 coincides with an angle (the inclination angle of the scanning line 22) θ1 made between the scanning line 22 and the signal line 20. The pixel 40 is arranged so that the diagonal line of the pixel 40 is aligned with one of the scanning lines 22. The intervals of the scanning lines 22 and the intervals of the signal lines 20 are determined so that the intersections of the scanning lines 22 and the signal lines 20 are linearly aligned lengthwise and widthwise.

In the display device of the present embodiment, in the oblique intersection area 10b, the scanning lines 22 are arranged in parallel with the oblique side of the octagonal display area 10, and the ratio of length to width of each pixel is determined in accordance with the inclination angle θ1 of the scanning lines 22, so that it is possible to efficiently align the rectangular pixels within the octagonal display area 10. Furthermore, because the intervals of the signal lines 20 and the intervals of the scanning lines 22 may be determined so that the intersections of the signal lines 20 and the scanning lines 22 are linearly aligned lengthwise and widthwise, it is possible to linearly align pixels lengthwise and widthwise in the entire area over the orthogonal intersection area 10a and the oblique intersection area 10b.

Note that, in the above example, the inclination angle θ1 of the scanning lines 22 and the ratio of length to width of the pixels are determined in accordance with the inclination angle of the oblique side of the display area 10. However, in contrast, the inclination angle of the oblique side of the display area 10, that is, the shape of the display area 10, may be determined in accordance with the ratio of length to width of the pixels.

### Third Embodiment

The display device provided with the display area including the orthogonal intersection area and the oblique intersection area is described in the first embodiment, whereas the display device provided only with an oblique intersection area will be described in the third embodiment.

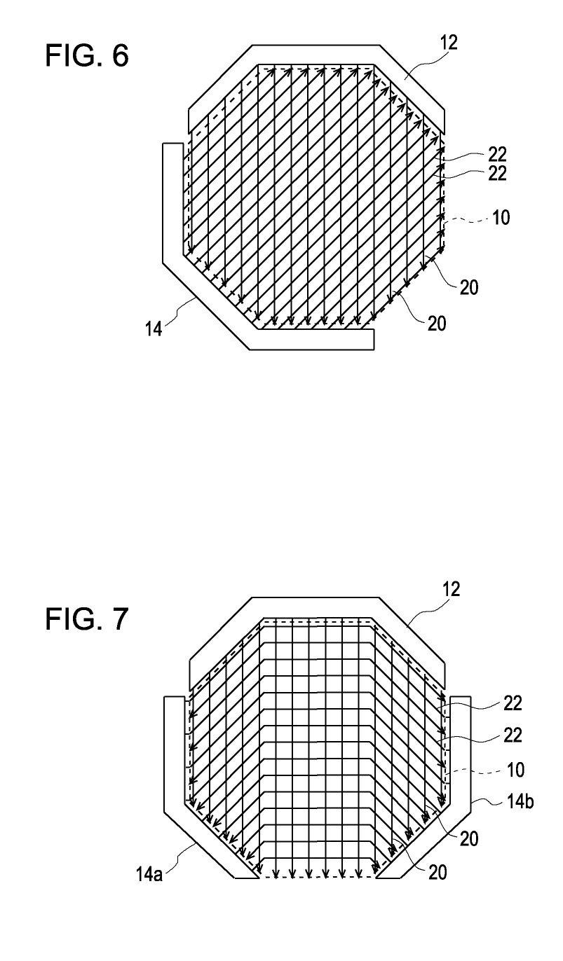

FIG. 6 is an explanatory view illustrating a wiring pattern of the display area of a display device according to the third embodiment. In FIG. 6, the components corresponding to those shown in FIG. 1 are given the same reference numerals, and description thereof is omitted.

As shown in FIG. 6, in the display area 10, a plurality of linear signal lines 20 and a plurality of linear scanning lines 22 are arranged so as to obliquely intersect each other. As to the intervals of the signal lines 20 and the intervals of the scanning lines 22, the positions of the intersections of the signal lines 20 and the scanning lines 22 are adjusted so that pixels are arranged in a matrix.

According to the present embodiment, because the possibility of wiring arrangement is increased by the oblique intersections of the signal lines and the scanning lines, and the scanning line driving circuit and the signal line driving circuit for sending various signals to the scanning lines and the signal lines may be arranged along the oblique side of the shape of the display area in accordance with the shape of the display area, the width of the window frame may be made small. In addition, because the entire display area is formed as the oblique intersection area, it may be formed of pixel cells each having a uniform shape. Thus, a manufacturing process is easier than the configuration of the display area that includes both the orthogonal intersection area and the oblique intersection area. Moreover, because a portion of sides of the shape of the display area need not be used for the scanning line driving circuit and the signal line driving circuit, it is advantageous to be able to ensure a space for arranging external connection terminals with the substrate, the crown of a watch, or the like.

### Fourth Embodiment

An example in which a gate driver is divided will be described in a fourth embodiment.

FIG. 7 is an explanatory view illustrating a display device according to the fourth embodiment. In FIG. 7, the components corresponding to those shown in FIG. 1 are given the same reference numerals, and description thereof is omitted.

In the display device according to the present embodiment, two gate drivers 14a, 14b are provided on both sides of the display area 10, as shown in FIG. 7. The scanning lines 22 are electrically connected alternately to the left and right gate drivers 14a, 14b. For example, the odd numbered scanning lines are electrically connected to the gate driver 14a, while the even numbered scanning lines 22 are electrically connected to the gate driver 14b. In addition, the scanning lines 22 extending from the left and right gate drivers 14a, 14b are arranged symmetrically so as to be aligned along (extend along) the upper three sides of the display area 10.

In the present embodiment, by dividing the gate driver into two, the wiring intervals between the scanning lines 22 within the gate drivers may be doubled, thus making it possible to easily design a circuit in accordance with the shape of a display area and a product shape.

### Fifth Embodiment

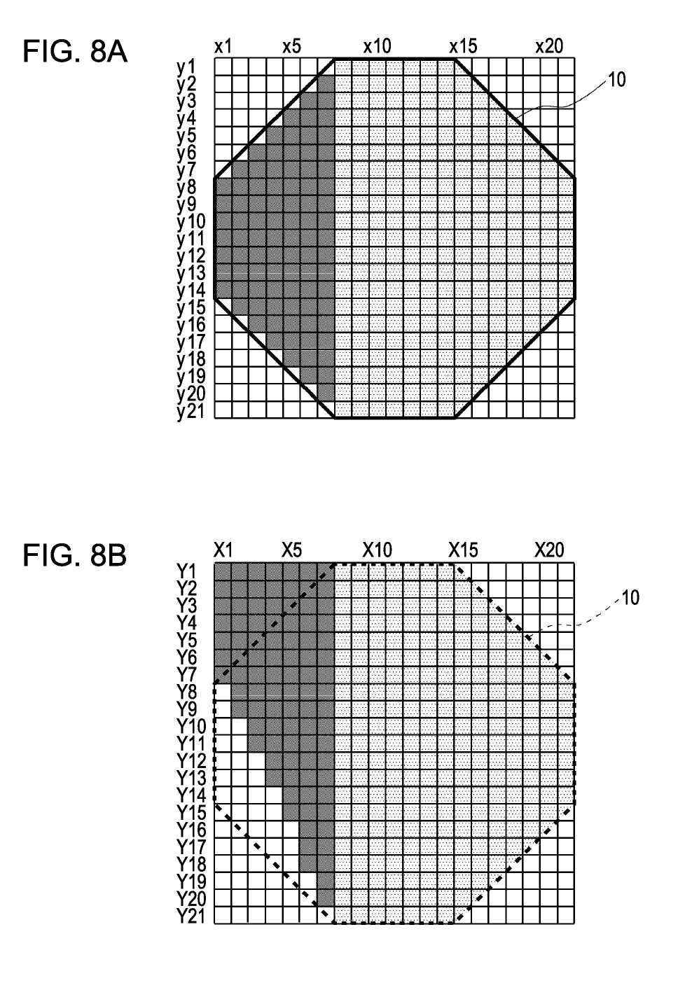

A fifth embodiment of the invention will be described with reference to FIG. 8A and FIG. 8B. FIGS. 8A and 8B are explanatory views illustrating how to supply image data to the display device in accordance with the layout of wirings in the first embodiment shown in FIG. 1. As shown in FIG. 8A and FIG. 8B, the display device includes an octagonal display area 10 by removing four corner edge areas of a rectangular display area, each corner area being formed of twenty-one rectangular pixels arranged lengthwise and widthwise. In FIG. 8A and FIG. 8B, the satin area in the drawing corresponds to the pixels of the orthogonal intersection area 10a (see FIG. 1) in which the scanning lines orthogonally intersect with the data lines. In addition, the dark area in the drawing corresponds to the pixels of the oblique intersection area 10b (see FIG. 1) in which the scanning lines obliquely intersect with the data lines. Hereinafter, as described specifically, the pixel data (FIG. 8A) of the oblique intersection area 10b, which form an image, are supplied to a display unit as image data (FIG. 8B) in which pixel positions are converted in accordance with the inclination of the scanning lines.

FIG. 8A shows an image, which will be displayed on the display screen of the display device. When pixels, which are expressed as orthogonal coordinate data of rows y1 to y21 and columns x1 to x21 as shown in FIG. 8A, are sequentially selected every scanning line 22 and displayed on the octagonal display area 10 that includes the oblique intersection area for displaying an image pattern (line sequential scanning data), the image data based on the orthogonal coordinate system needs to be converted to data based on a coordinate system defined by the signal lines 20 and the scanning lines 22 including the inclined wiring portion and the straight wiring portion. FIG. 8B shows an image that is obtained by converting the image shown in FIG. 8A to the coordinate data defined by X1 to X21 signal lines 20 and Y1 to Y21 scanning lines 22.

In such image conversion, image data that have been converted externally may be given to the display unit, or image data that are not converted may be converted at the pixel array conversion portion for display. An additional CPU may be provided for image conversion. The following will specifically describe how to convert an image, taking the above case for example.

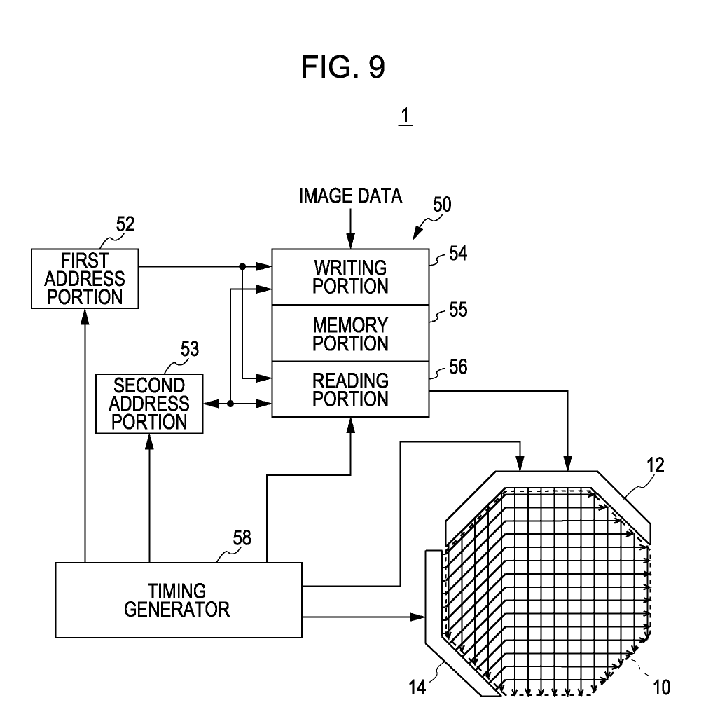

FIG. 9 is a view schematically illustrating a pixel array conversion portion 50 for use in the display device according to the present embodiment. As shown in FIG. 9, the display device 1 includes a display area 10 formed of a plurality of pixels arranged in a matrix, the data driver 12, the gate driver 14, a first address output portion 52 that outputs addresses by which data are written into the memory portion 55, a second address output portion 53 that outputs addresses by which data are read out from the memory portion 55, a writing portion 54 that writes image data supplied from the outside into the memory portion 55 in accordance with the writing addresses, a reading portion 56 that reads out image data from the memory portion 55 in accordance with the reading addresses, and a timing generator 58. The first address output portion 52, the second address output portion 53, the writing portion 54, the memory portion (storage portion) 55 and the reading portion 56 cooperate to form the pixel array conversion portion 50.

According to the above configuration, the pixel array conversion portion 50 writes image data, which will be displayed in the display area, into the memory portion 55 using the writing addresses that correspond to the line sequential scanning of an image. Next, the pixel array conversion portion 50 reads out pixel data from the memory portion 55 using the reading addresses that correspond to the scanning lines including the oblique intersection portion. The array of pixel data that have been read out are supplied to the data driver 12 as image data.

For example, a series of image data D(1), D(2), . . . , D(441) obtained by line sequential scanning of an image, output from a pattern generator (not shown) are written into the memory portion 55 using consecutive first addresses as D(x1, y1), D(x2, y1), D(x3, y1), . . . , D(x20, y21), D(x21, y21). Note that, as shown in FIG. 8A, because image data in an area (corner portion) other than portions corresponding to the display area 10 will not be displayed, the output of that area of the pattern generator may be set for “0” in advance.

Next, pixel data are read out using the second addresses that correspond to the positions of arrangement of the first scanning line 20 (Y1) that includes the inclined portion (oblique intersection portion). For example, image data D(x1, y8), D(x2, y7), D(x3, y6), D(x4, y5), D(x5, y4), D(x6, y3), D(x7, y2), D(x8, y1), D(x9, y1), D(x10, y1), D(x11, y1), D(x12, y1), D(x13, y1), D(x14, y1), D(x15, y1), . . . , D(x21, y1) are read out. Here, the image data D(x15, y1), . . . , D(x21, y1) are not displayed because of the outside of the area 10, so that data such as “0” as described above may be entered therein.

Next, pixel data are read out using the second addresses that correspond to the positions of arrangement of the second scanning line 20 (Y2). For example, pixel data D(x1, y9), D(x2, y8), D(x3, y7), D(x4, y6), D(x5, y5), D(x6, y4), D(x7, y3), D(x8, y2), D(x9, y2), D(x10, y2), D(x11, y2), D(x12, y2), D(x13, y2), D(x14, y2), D(x15, y2), D(x16, y2), . . . , D(x21, y2) are read out. Here, the pixel data D(x16, y2), . . . , D(x21, y2) are not displayed because of the outside of the area 10, so that data such as “0” as described above may be entered therein.

In this manner, pixel data are continuously read out using the second addresses that correspond to the positions of arrangement of the second scanning lines 20 (Yn), thus obtaining image data to which the positions of pixel data of the oblique intersection area are converted. The image data are then supplied to the data driver 12. The array of the image data that have been read out is shown in a continuous manner by FIG. 8B.

In addition, on the basis of the results of the pixel data position conversion, the positions of pixel data may be converted when writing a series of image data D(1) to D(441) into the memory portion and may be read out by line sequential scanning when reading out the image data. That is, the supplied image data are written using address positions of the memory portion 55 corresponding to the scanning lines that include wirings that obliquely intersect each other and pixel data are then read out from the memory portion 55 using the reading addresses of the line sequential operation (see FIG. 8B).

For example, a series of image data D(1), D(2), . . . , D(441) output from the pattern generator (not shown), based on the line sequential scanning of an image, may be written into the memory portion 55 by moving the pixel data D(28), D(48), D(49), . . . , D(406) in the oblique intersection area out of a series of image data D(1) to D(441) so that the pixel data D(1) through D(7) are removed, D(8) through D(21) are moved into D(X8, Y1) through D(X21, Y1), D(22) through D(27) are removed, the pixel data of the oblique intersection area D(28) is moved into D(X7, Y1), D(29) through D(42) are moved into D(X8, Y2) through D(X21, Y2), D(43) through D(47) are removed, the pixel data of the oblique intersection area D(48) is moved into D(X6, Y1), D(49) is moved into D(X7, Y2), D(50) through D(63) are moved into D(X8, Y3) through D(X21, Y3), . . . , D(421) through D(427) are removed, D(428) through D(441) are moved into D(X8, Y21) through D(X21, Y21).

Note that, in this example as well, as shown in FIG. 8A, because image data in an area (four corner portions) other than the portions corresponding to the display area 10 will not be displayed, the output of that area of the pattern generator may be set for “0” in advance. The array of pixel data that have been read out are supplied to the data driver 12 as image data. Even in this manner, because the pixel array of the original image data is converted in response to the bending of the scanning lines that include the oblique intersection portion, the original image is reproduced appropriately for the display area.

In addition, it is applicable that, by using an address conversion table between two coordinate systems, which is prepared in advance, addresses of pixels of supplied image data are converted to the corresponding addresses, pixel data are sorted in the order of the converted addresses to obtain image data, which will be supplied to the data driver 12.

The coordinate conversion table may employ, for example, a table in which coordinates represented by the orthogonal coordinate system are in a one-to-one correspondence with coordinates represented by the conversion coordinate system so that, when the pixel data of the supplied image are defined as D(m, n), D(x1, y8) corresponds to D(X1, Y1), D(x1, y9) to D(X1, Y2), . . . , D(x7, y20) to D(X7, Y19), D(x7, y21) to D(X7, Y20) (see FIG. 8A and FIG. 8B). Note that image data may be obtained not by the coordinate conversion table but by processing utilizing the regularity of pixel array.

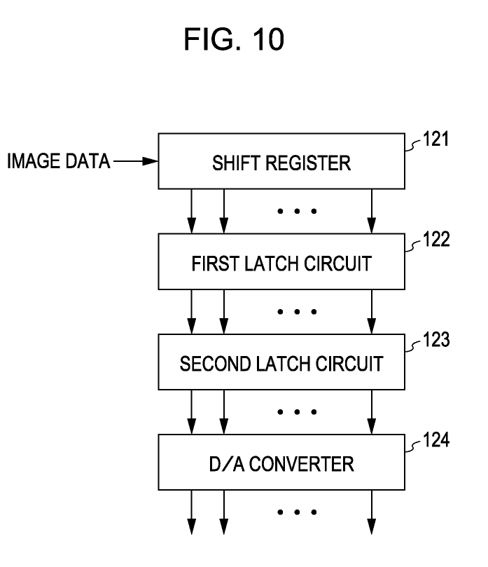

FIG. 10 is a block diagram of the data driver 12. As shown in FIG. 10, the data driver 12 includes a shift register 121 executes serial-parallel conversion of supplied image data, a first latch circuit 122, a second latch circuit 123, a D/A conversion circuit 124 that generates a luminance signal voltage corresponding to a latch value, or the like. The outputs of the D/A conversion circuit 124 are output to the data lines 20 synchronously with selection of the scanning line 22. In this manner, each pixel of the display area is driven at a level that is individually set and an image is formed in the display area.

According to the present embodiment, because there is provided a device for converting an original image to an image for output (output image), it is possible to convert an original image stored in the storage portion (image memory) to an output image in accordance with the arrangement of the scanning lines and the signal lines upon output of the image. In addition, because the pixel array conversion is executed by the display device, it is possible to omit a process for converting an image by means of an external device beforehand when the image is input from the outside. Furthermore, with the conversion table, complex computing, or the like, is not required, making it possible to easily convert coordinates and to perform a high-speed processing.

Note that, in the above example, the pixel array conversion is executed within the display device 1. However, the pixel array conversion may be separately executed by means of an external device and the image data for which the pixel array conversion has been executed may be supplied to the display unit.

### Sixth Embodiment

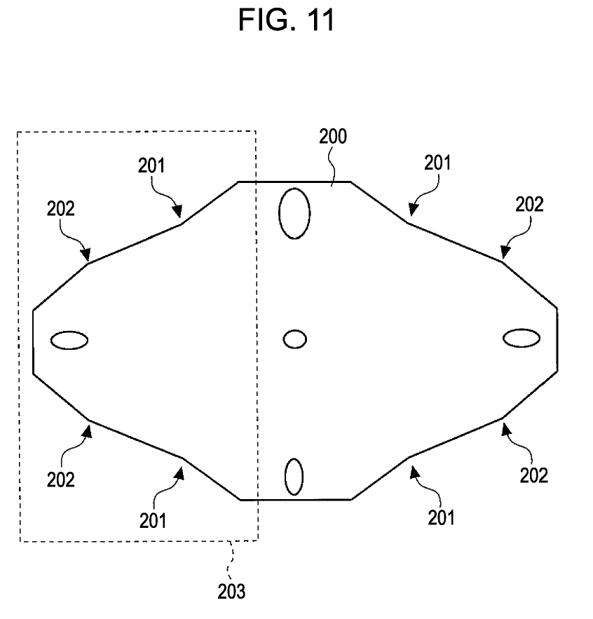

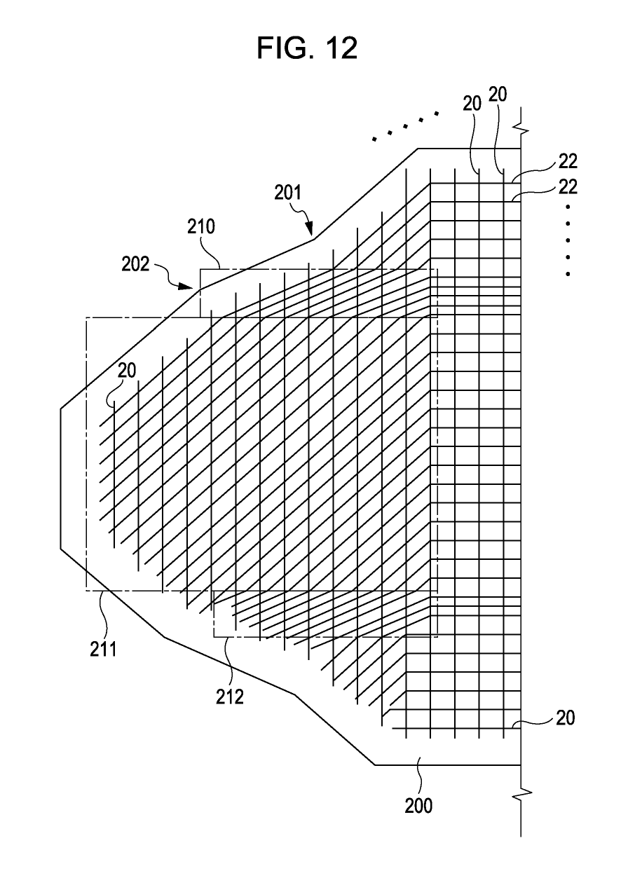

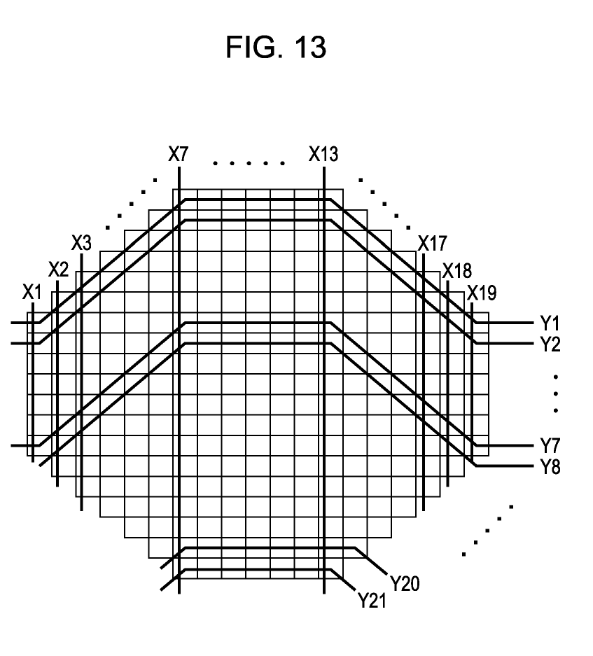

In the sixth embodiment, a configuration example of a display device in which the scanning lines and the signal lines obliquely intersect each other at a plurality of different angles will be described with reference to FIG. 11 and FIG. 12. FIG. 11 is an example of a display board of a watch. The display board 200 shown in FIG. 11 has oblique sides each changing an angle halfway at two portions. Specifically, the angles at which each oblique side extends change at angle changing portions 201 and angle changing portions 202 in the drawing. FIG. 12 shows the scanning lines 22 and the signal lines 20 with a specific area 203 of the display board 200 being partially enlarged. Even when the display board 200 has a shape including a plurality of angle changing portions, as shown in FIG. 12, it is possible to form a display board by changing angles (oblique intersection angles) at which the scanning lines 22 and the signal lines 20 intersect each other. For example, by comparison between an area 210 and an area 211 shown in FIG. 12, the area 210 has larger intersection angles between the scanning lines 22 and the signal lines 20, while the area 211 has smaller intersection angles between the scanning lines 22 and the signal lines 20. Similarly, by comparison between an area 212 and the area 211 shown in FIG. 12, the area 212 has larger intersection angles between the scanning lines 22 and the signal lines 20, while the area 211 has smaller intersection angles between the scanning lines 22 and the signal lines 20. As shown in the drawing, the scanning lines 22 are bent at a boundary between the mutually adjacent area 210 and area 211. Similarly, the scanning lines 22 are bent at a boundary between the mutually adjacent area 211 and area 212. In this manner, when the intersection angles between the scanning lines 22 and the signal lines 20 are different among the areas, it is only necessary to vary the size of pixels provided in correspondence with the intersections of the scanning lines 22 and the signal lines 20 in the areas. Specifically, in the areas 210, 212 having larger intersection angles between the scanning lines 22 and the signal lines 20, it is only necessary to reduce the size of pixels as compared with that of the area 211. Note that, in the example shown in FIG. 12, the scanning lines 22 are bent at the boundaries between the plurality of adjacent areas; however, the signal lines 20 may be bent or both the scanning lines 22 and the signal lines 20 may be bent. This increases the possibility of arrangement of pixels.

### Seventh Embodiment

In the seventh embodiment, an example of data arrangement in the memory portion (storage portion) in the above described embodiments and a relationship between the first addresses and the second addresses in the example of data arrangement will be described. FIG. 13 is a schematic view of the display area 10 of a display body for the purpose of illustrating the seventh embodiment. Each grid rectangle corresponds to a pixel. Twenty-one scanning lines Y1, Y2, . . . , Y21 each supply a selection signal to pixels shown in the drawing. In addition, nineteen signal lines X1, X2, . . . , X19 each are shared by a plurality of pixels aligned in a longitudinal direction in the drawing. As is apparent from FIG. 13, the first scanning line Y1 through the seventh scanning line Y7 each occupy a maximum number of corresponding pixels, and the number of pixels corresponding to a scanning line gets smaller from the eighth scanning line Y8 toward the twenty-first scanning line Y21.

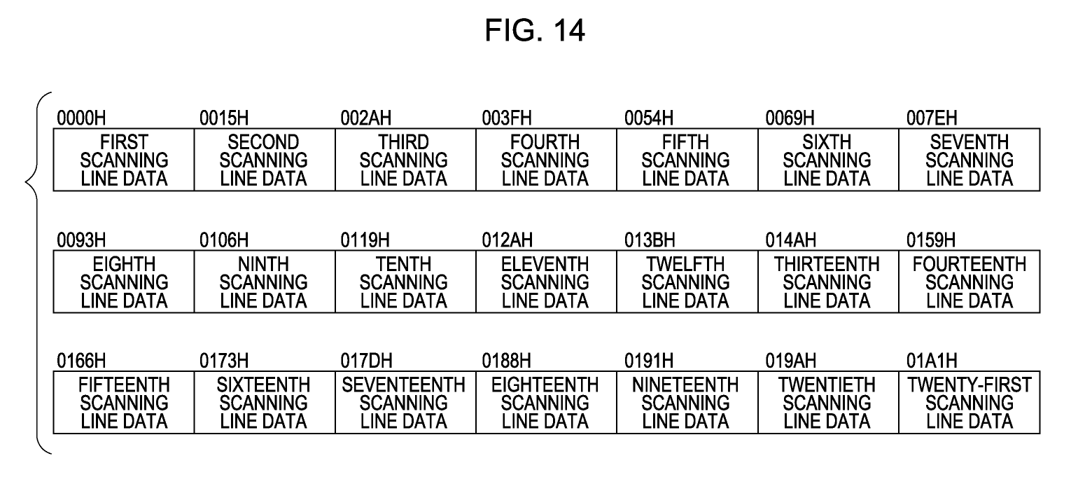

FIG. 14 shows an example of arrangement of image data stored in the memory portion 55 in correspondence with the display area in which the scanning lines, the signal lines and the pixels are arranged as described above. In the drawing, an example of data storage address is shown on the upper left side of each scanning line data. FIG. 14 shows the arrangement of image data for one screen. A plurality of image data may also be stored in the memory portion 55 by repeating the arrangement of image data shown in FIG. 14. The arrangement of image data in the memory portion 55 is accordant with the selection of the scanning lines, that is, the image data are arranged on the basis of the second addresses. The image data are read out in the order of the second addresses and supplied to the signal lines corresponding to the positions of the pixels.

### Eighth Embodiment

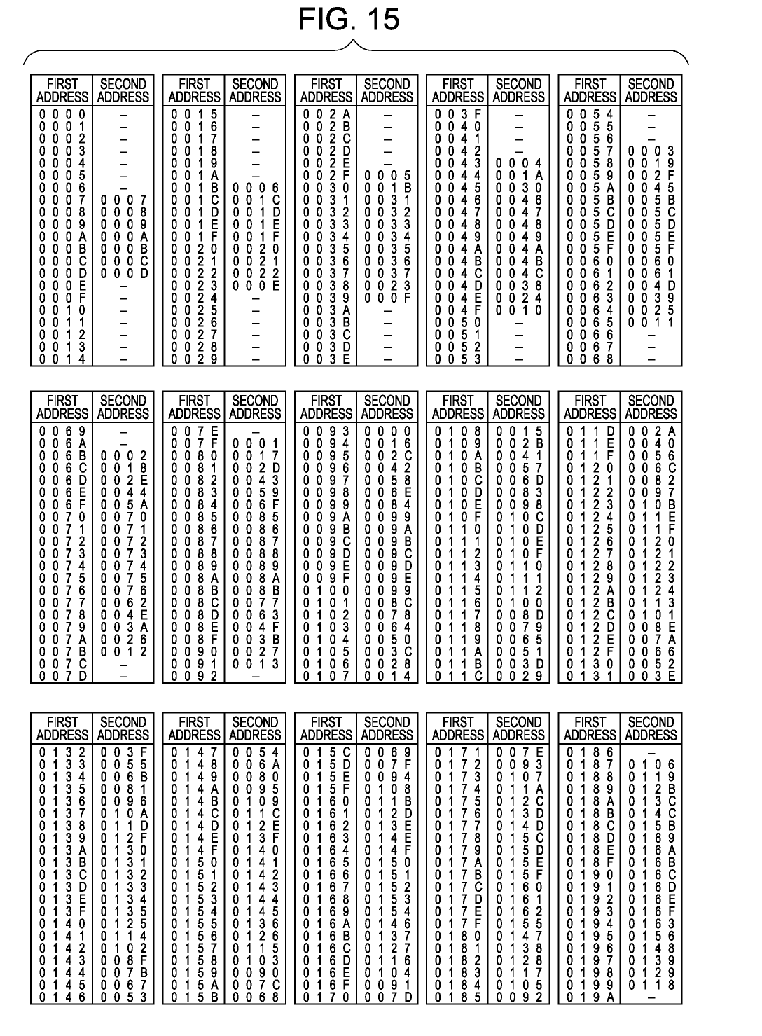

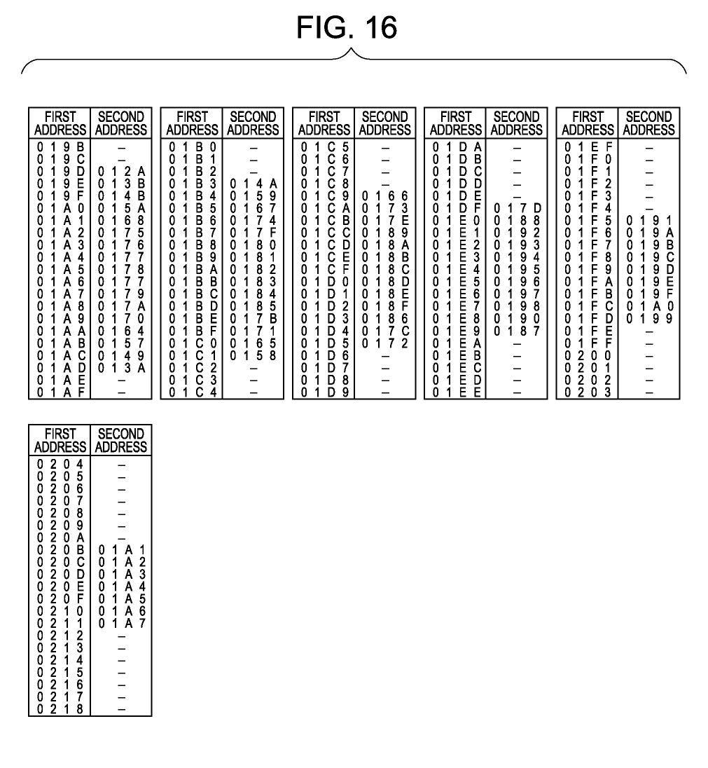

In the eighth embodiment, taking the display area in the seventh embodiment for example, the conversion of array of image data using the memory portion 55, the first addresses and the second addresses will be described. In this embodiment, the correspondence between the first addresses and the second addresses is shown in FIG. 15 and FIG. 16. In the drawings, the first addresses are shown in the left columns, and the second addresses that are in a one-to-one correspondence with the first addresses are shown in the right columns. For example, the second address that corresponds to the first address “0007” is “0007”, the second address that corresponds to the first address “0008” is “0008”, . . . , and the second address that corresponds to the first address “000D” is “000D”. In addition, the second address that corresponds to the first address “001B” is “0006”, the second address that corresponds to the first address “001C” is “001C”, . . . , and the second address that corresponds to the first address “0023” is “000E”. The same applies to the other columns, and further description is omitted.

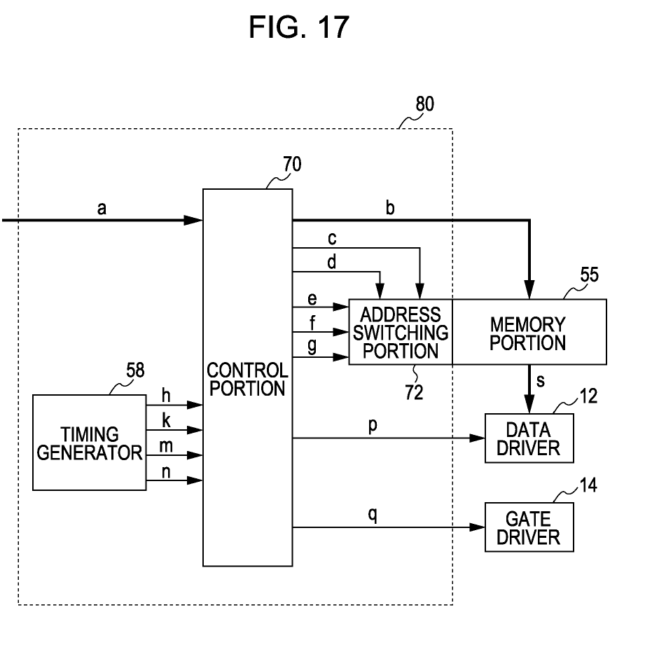

FIG. 17 is a block diagram showing a portion of the display device according to the eighth embodiment. The original image data a are image data that contain pixels for forming the image data and position information of the pixels. The original image data a are sorted, by a control portion 70 shown in the drawing, using the first addresses in a first order that corresponds to the array of a plurality of pixels or using the second addresses in a second order that corresponds to selection signals. Then, the sorted image data, together with address selection signals e that correspond to the addresses being used, are supplied to the memory portion (storage portion) 55 as input image data b synchronously with the first addresses c or the second addresses d. The addresses selected for the address selection signals e are addresses used for writing operation to the memory portion 55. A writing control signal f and a reading control signal g to the memory portion 55 are supplied appropriately from the control portion 70 to an address switching portion 72. When the image data stored in the memory portion 55 are read out, the second addresses are used. The timing generator 58 supplies a control portion timing signal h, a control portion timing signal k, a signal line driving circuit timing signal m, and a scanning line driving circuit timing signal n to the control portion 70. The control portion 70 supplies a signal line driving circuit control signal p to the data driver (signal line driving circuit) 12 and supplies a scanning line driving circuit control signal q to the gate driver (scanning line driving circuit) 14. The timing generator 58, the control portion 70 and the address switching portion 72 cooperate to form an image array conversion portion 80.

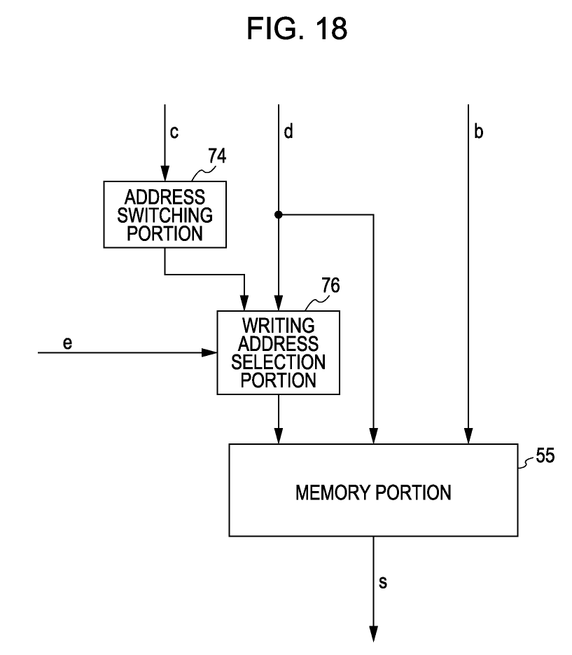

FIG. 18 is a block diagram showing the memory portion 55 and one example of a detailed configuration of the address switching portion shown in FIG. 17. The input image data b, when stored in the memory portion 55 using the second addresses, are stored in the memory portion 55 at positions pointed by the second addresses. When the image data are supplied to the memory portion 55 using the first addresses, the first addresses are converted by an address conversion portion 74 shown in FIG. 18 on the basis of the correspondence relationship shown in FIG. 15 and FIG. 16 and the image data are then stored in the memory portion 55 at the positions pointed by the converted addresses. In this manner, the input image data b are stored in the memory portion 55 in the arrangement indicated by the second addresses.

### Ninth Embodiment

In the ninth embodiment, the case in which writing of image data into the memory portion 55 are executed in parallel with reading of image data from the memory portion 55 will be described. The configuration of the display area and display device is the same as those of the above described seventh embodiment and eighth embodiment. Note, however, that the memory portion 55 has a capacity that is capable of storing a plurality of pieces of image data. When the reading of image data stored in a first area of the memory portion 55 and the writing of image data into a second area (different from the first area) of the memory portion 55 are executed, the writing operation is executed using the first addresses and the reading operation is executed using the second addresses. The original image data a are replaced by an array of first image data at the control portion 70, and the address selection signal e is fixed to a value for selecting the first addresses. The control portion 70 is able to switch an image displayed in the display area by selecting an area of the memory portion 55, in which different image data are stored, using the second addresses among image data stored in the memory portion 55.

### Tenth Embodiment

The following will describe an example of an electronic apparatus that is provided with the above described display device. Note that the above described display device is assembled to the following electronic apparatuses as a display portion.

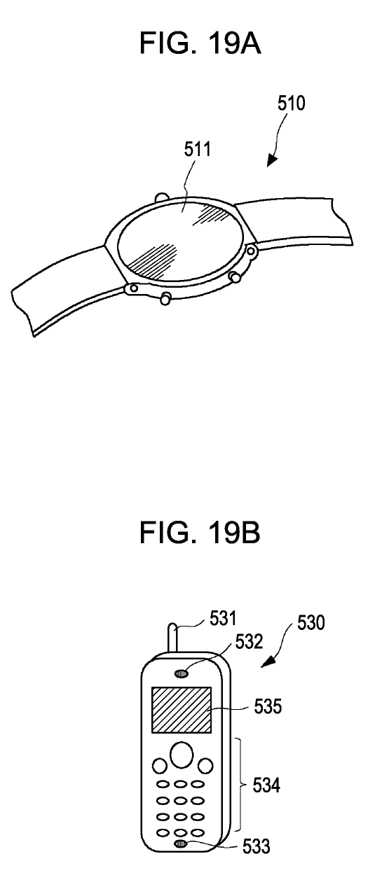

FIG. 19A and FIG. 19B are schematic perspective views each showing an example of electronic apparatus. FIG. 19A is an example of application to a watch. The watch 510 is provided with a display portion 511 that is formed of a color display according to the embodiments of the invention. FIG. 19B is an example of application to a mobile telephone. The mobile telephone 530 is provided with an antenna portion 531, an audio output portion 532, an audio input portion 533, an operating portion 534, and a display portion 535.

The invention is not limited to the embodiments described above but may be modified into various forms within the scope of the invention.

What is claimed is:

1. A display device comprising:
a plurality of pixels that correspond to intersections of a plurality of scanning lines and a plurality of signal lines;
a scanning line driving circuit that supplies a selection signal to each of the plurality of scanning lines; and
a signal line driving circuit that supplies a pixel signal to each of the plurality of signal lines, wherein
the plurality of pixels are arranged in a matrix in a display area of the display device, and
at least a specific area of the display area is an area in which at least one of the plurality of scanning lines obliquely intersects at least one of the plurality of signal lines.

2. The display device according to claim 1, wherein at least one of the plurality of scanning lines and the plurality of signal lines are bent at a boundary between the specific area and the other area of the display area.

3. The display device according to claim 1, wherein the display area has an octagonal shape.

4. The display device according to claim 3, wherein the scanning line driving circuit and the signal line driving circuit each are disposed along a part of an outer periphery of the display area.

5. The display device according to claim 1, wherein the plurality of pixels each have a rectangular shape, and wherein, in the specific area, one of the plurality of scanning lines and the plurality of signal lines are arranged in parallel with one of a lengthwise side and widthwise side of each of the plurality of pixels, while the other of the plurality of scanning lines and the plurality of signal lines are arranged in parallel with a diagonal line of each of the plurality of pixels.

6. The display device according to claim 1, wherein the display area has a substantially regular octagonal shape, wherein one of the plurality of scanning lines and the plurality of signal lines are arranged in parallel with each other so as to orthogonally intersect a side of the display area, and wherein the plurality of scanning lines and the plurality of signal lines are disposed so as to obliquely intersect each other at an angle of 45 degrees in the specific area.

7. The display device according to claim 1, wherein the specific area includes a plurality of areas in which the plurality of scanning lines and the plurality of signal lines obliquely intersect each other at different angles.

8. The display device according to claim 7, wherein at least one of the plurality of scanning lines and the plurality of signal lines are bent at boundaries between any adjacent plurality of areas in which the plurality of scanning lines and the plurality of signal lines obliquely intersect each other at different angles.

9. The display device according to claim 1, further comprising:
a storage portion that stores image data to be displayed in the display area; and
an image array conversion portion that controls the storage portion, wherein
the image array conversion portion uses first addresses when writing the image data into the storage portion in a first order that corresponds to a sequence of an array of the plurality of pixels,
the image array conversion portion uses second addresses when writing the image data into the storage portion in a second order that corresponds to a sequence based on the selection signal, and
the image array conversion portion uses the second addresses when reading out the image data, which are stored in the storage portion, into the display area.

10. The display device according to claim 9, wherein the storage portion has a capacity that is capable of storing a plurality of pieces of the image data, and wherein a reading operation by which the image data stored in a first storage area of the storage portion are read out is executed in parallel with a writing operation by which the image data are written, using the first addresses, into a second storage area of the storage portion, which is different from the first storage area.

11. A display device comprising:
a display area that is formed of a plurality of pixels arranged in a first area and a second area of the display area;
a plurality of signal lines that extend in one direction in the first area and in the second area;
a plurality of scanning lines that orthogonally intersect a portion of the plurality of signal lines in the first area and that obliquely intersect another portion of the plurality of signal lines in the second area;
a signal line driving circuit that is arranged along a part of an outer periphery of the first area and second area and that supplies a pixel signal to each of the plurality of signal lines;
a scanning line driving circuit that is arranged along another part of the outer periphery of the second area and that supplies a selection signal to each of the plurality of scanning lines; and
a plurality of pixel driving circuits that are respectively provided at intersections of the plurality of scanning lines and the plurality of signal lines and that drive the pixels on the basis of the pixel signal and the selection signal.

12. The display device according to claim 11, further comprising:
a pixel array conversion portion that writes supplied image data, which will be displayed in the display area, into a storage portion in a first order or in a second order and that supplies the image data from the storage portion to the signal line driving circuit by reading the image data in the second order or in the first order in correspondence with the first order or the second order in which the image data have been written into the storage portion, wherein
writing or reading in the first order is executed using first addresses that correspond to an array in which the pixels are arranged in the display area, and
writing or reading in the second order is executed using second addresses that correspond to an array in which the pixels are sequentially driven by the plurality of scanning lines and the plurality of signal lines, which include wirings that obliquely intersect each other.

13. A display device comprising:
an octagonal display area that is formed of a plurality of pixels arranged in a matrix;
a plurality of signal lines that extend in one direction in the display area;
a plurality of scanning lines that orthogonally intersect a portion of the plurality of signal lines in a first area of the display area and that orthogonally intersect another portion of the plurality of signal lines in a second area of the display area;
a signal line driving circuit that is arranged along a part of an outer periphery of the first area and second area of the display area and that supplies a pixel signal to each of the plurality of signal lines;
a scanning line driving circuit that is arranged along another part of the outer periphery of the second area of the display area and that supplies a selection signal to each of the plurality of scanning lines; and
a plurality of pixel driving circuits that are respectively provided at intersections of the plurality of scanning lines and the plurality of signal lines and that drive the pixels on the basis of the pixel signal and the selection signal.

14. A display device comprising:
a display area that is formed of a plurality of pixels arranged in a matrix;
a plurality of signal lines that extend in one direction in the display area;
a plurality of scanning lines that obliquely intersect the plurality of signal lines in the display area;
a signal line driving circuit that is arranged along a part of an outer periphery of the display area and that supplies a pixel signal to each of the plurality of signal lines;
a scanning line driving circuit that is arranged along another part of the outer periphery of the display area and that supplies a selection signal to each of the plurality of scanning lines; and
a plurality of pixel driving circuits that are respectively provided at intersections of the plurality of scanning lines and the plurality of signal lines and that drive the pixels on the basis of the pixel signal and the selection signal.

15. The display device according to claim 1, wherein at least one of the scanning line driving circuit and the signal line driving circuit is provided in plural numbers along an outer periphery of the display area.

16. An electronic apparatus comprising the display device according to claim 1.

17. A method of converting image data used for a display device that includes a display area that is formed of pixels arranged in a matrix in correspondence with intersections of a plurality of scanning lines and a plurality of signal lines, wherein the display area at least partially includes an oblique intersection area in which the scanning lines and the signal lines obliquely intersect each other, the method comprising:
writing supplied image data, which will be displayed in the display area, into a storage portion in a first order or in a second order;
converting an array of pixels in the image data by reading the image data from the storage portion in the second order or in the first order that corresponds to the first order or the second order in which the image data have been written into the storage portion, wherein
writing or reading in the first order is executed using first addresses that correspond to an array in which the pixels are arranged in the display area, and
writing or reading in the second order is executed using second addresses that correspond to an array in which the pixels are sequentially driven by the plurality of scanning lines and the plurality of signal lines, which include wirings that obliquely intersect each other.
